(19) United States
(12) Patent Application Publication
(10) Pub. No.: US 2006/0260291 A1
(43) Pub. Date: Nov. 23, 2006

(54) Pulse detonation assembly with cooling enhancements

(75) Inventors: Christian Lee Vandervort, Voorheesville, NY (US); Adam Rasheed, Glenville, NY (US); Anthony John Dean, Scotia, NY (US); Venkat Eswarlu Tangirala, Niskayuna, NY (US); Pierre Francois Pinard, Delmar, NY (US); James Fredric Wiedenhoefer, Glenville, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/135,195

(22) Filed: May 20, 2005

(51) Int. Cl. F02C 5/00

(52) U.S. Cl. 60/39.76

(57) ABSTRACT

A pulse detonation (PD) assembly includes at least one PD chamber having a wall, which defines cooling holes arranged along at least a portion of the PD chamber. A manifold extends around the PD chamber. The manifold and PD chamber are separated by a bypass region. A PD assembly with reverse flow cooling includes at least one PD chamber. A sleeve extends around the PD chamber. The sleeve and PD chamber are separated by a reverse flow cooling passage configured to receive a flow of air and to flow the air in a reverse direction to supply the PD chamber. A PD assembly with bypass flow cooling includes at least one PD chamber and a manifold extending around the PD chamber(s), which are separated by a bypass region. The PD assembly further includes a mixing plenum configured to receive and mix the bypass flow from the bypass region and the detonation by-products from the PD chamber(s).

### BACKGROUND

The invention relates generally to pulse detonation assemblies, and more particularly, to cooling enhancements for pulse detonation assemblies.

Pulse detonation engines are a promising propulsion and power generation technology, in view of the lower entropy rise of detonative processes, as compared to constant pressure deflagration. Consequently, pulse detonation engines have the potential to propel vehicles at higher thermodynamic efficiencies than are achieved with deflagration-based engines.

However, pulse detonation engines are subject to both overheating and noise problems. For experimental or prototype applications, overheating is typically prevented by operating the pulse detonation tube for only a short period of time, typically in the range of seconds. Noise has been addressed for experimental or prototype arrangements by performing tests in closed, acoustically treated test cells. Neither of these techniques is acceptable for practical applications of pulse detonation engines. Accordingly, it would be desirable to develop systems and methods for cooling pulse detonation engines. It would further be desirable to reduce noise for pulse detonation engines.

### BRIEF DESCRIPTION

Yet another aspect of the present invention resides in a PD assembly with reverse flow cooling and heat transfer enhancements. The PD assembly includes at least one PD chamber and a sleeve extending around the PD chamber(s). The sleeve and the PD chamber are separated by a reverse flow cooling passage. The PD assembly further includes an air source configured to supply primary air to the reverse flow cooling passage. The reverse flow cooling passage is configured to receive the primary air and to supply the primary air to the at least one PD chamber. A number of heat transfer enhancements are formed on an exterior surface of the wall. The heat transfer enhancements are configured to enhance heat transfer from the PD chamber to the reverse flow cooling passage.

Yet another aspect of the present invention resides in a PD assembly with bypass flow cooling. The PD assembly includes at least one PD chamber and a manifold extending around the PD chamber(s). The manifold and the PD chamber are separated by a bypass region configured to receive and conduct a bypass flow.

### DRAWINGS

These and other features, aspects, and advantages of the present invention will become better understood when the following detailed description is read with reference to the accompanying drawings in which like characters represent like parts throughout the drawings, wherein:

FIG. 1 shows a pulse detonation assembly with bypass air and film cooling;

FIG. 2 shows exemplary film cooling holes for the pulse detonation assembly of FIG. 1 in greater detail;

FIG. 3 shows an exemplary film cooling hole with a chamfered opening;

FIG. 4 depicts a pulse detonation assembly with both impingement and film cooling;

FIG. 5 depicts a pulse detonation assembly with reverse flow cooling;

FIG. 6 illustrates a pulse detonation assembly with combined reverse flow cooling and film cooling;

FIG. 7 illustrates a pulse detonation assembly with reverse flow cooling, impingement cooling and film cooling;

FIG. 8 illustrates a pulse detonation assembly with combined reverse flow cooling and impingement cooling; and

FIG. 9 shows a pulse detonation assembly with bypass air cooling.

### DETAILED DESCRIPTION

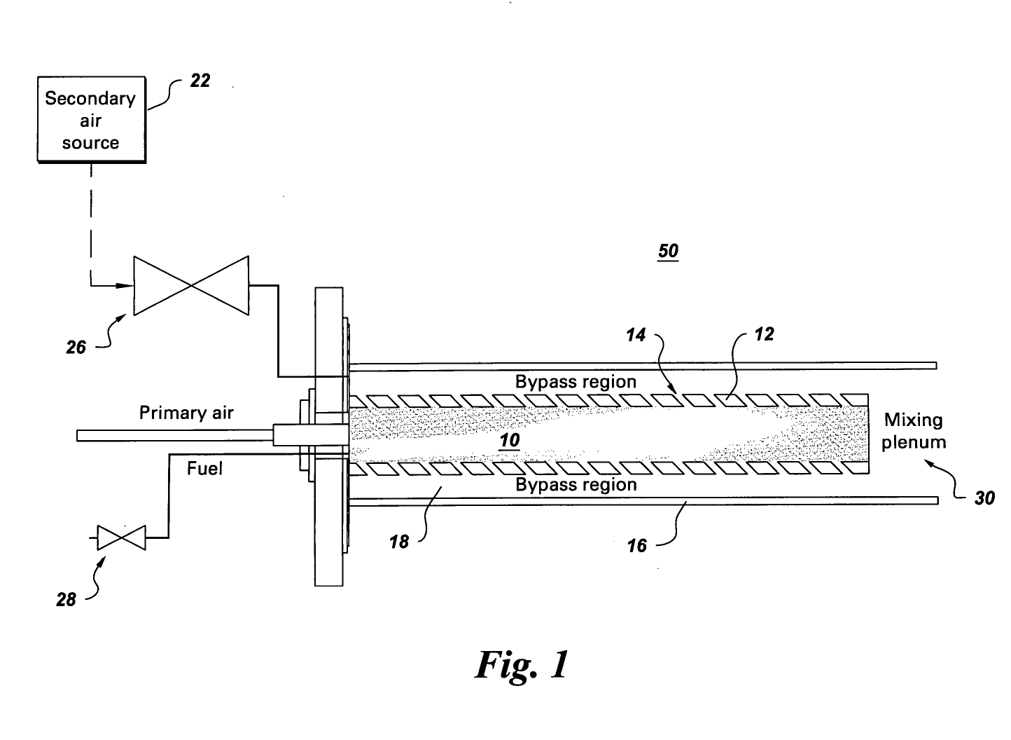

A first pulse detonation (PD) assembly 50 is described with reference to FIG. 1. As shown, PD assembly 50 includes at least one PD chamber 10, which has a wall 12 that defines a number of cooling holes 14. Cooling holes 14 are arranged along at least a portion of PD chamber(s) 10. PD assembly 50 further includes a manifold 16 (for example, an annular manifold) extending around PD chamber 10. Manifold 16 and PD chamber(s) 10 are separated by a bypass region 18.

As used herein, a “pulse detonation chamber” (or “PD” chamber) is understood to mean any combustion device or system where a series of repeating detonations or quasi-detonations within the device cause a pressure rise and subsequent acceleration of the combustion products as compared to the pre-bumed reactants. A “quasi-detonation” is a combustion process that produces a pressure rise and velocity increase higher than the pressure rise produced by a deflagration wave. Typical embodiments of PD chambers include a means of igniting a fuel/oxidizer mixture, for example a fuel/air mixture, and a confining chamber, in which pressure wave fronts initiated by the ignition process coalesce to produce a detonation wave. Each detonation or quasi-detonation is initiated either by external ignition, such as spark discharge or laser pulse, or by gas dynamic processes, such as shock focusing, autoignition or by another detonation via cross-firing. The geometry of the detonation chamber is such that the pressure rise of the detonation wave expels combustion products out the PD chamber exhaust to produce a thrust force. As known to those skilled in the art, pulse detonation may be accomplished in a number of types of detonation chambers, including detonation tubes, shock tubes, resonating detonation cavities and annular detonation chambers.

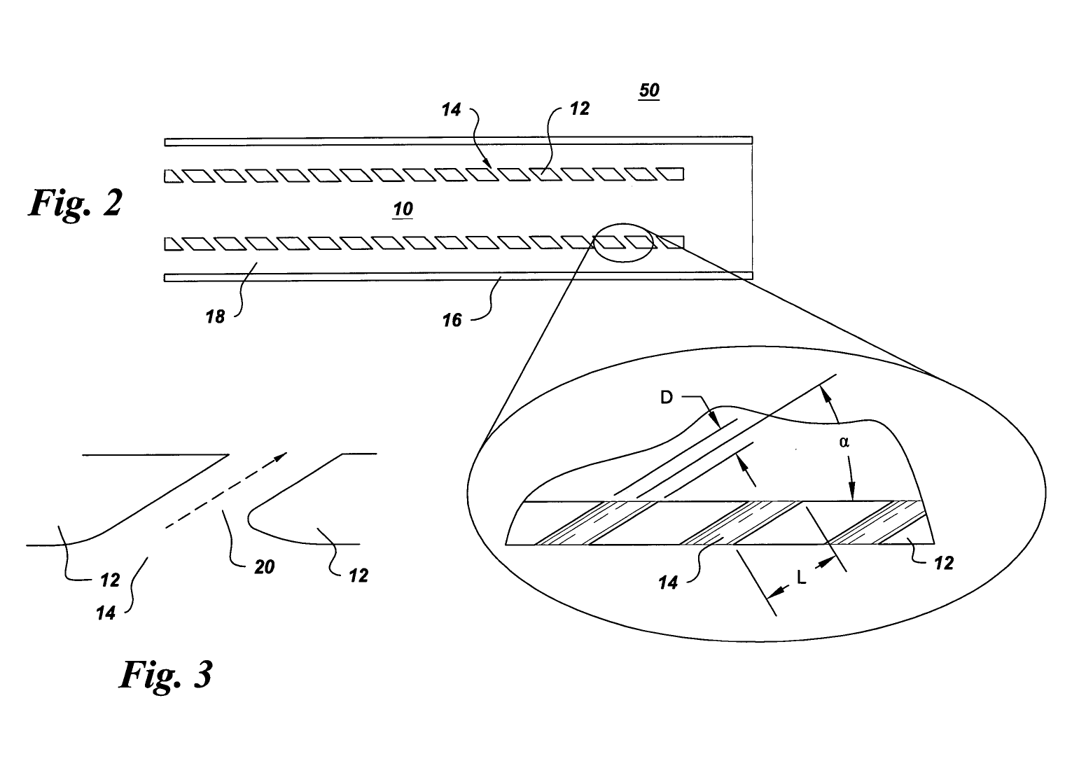

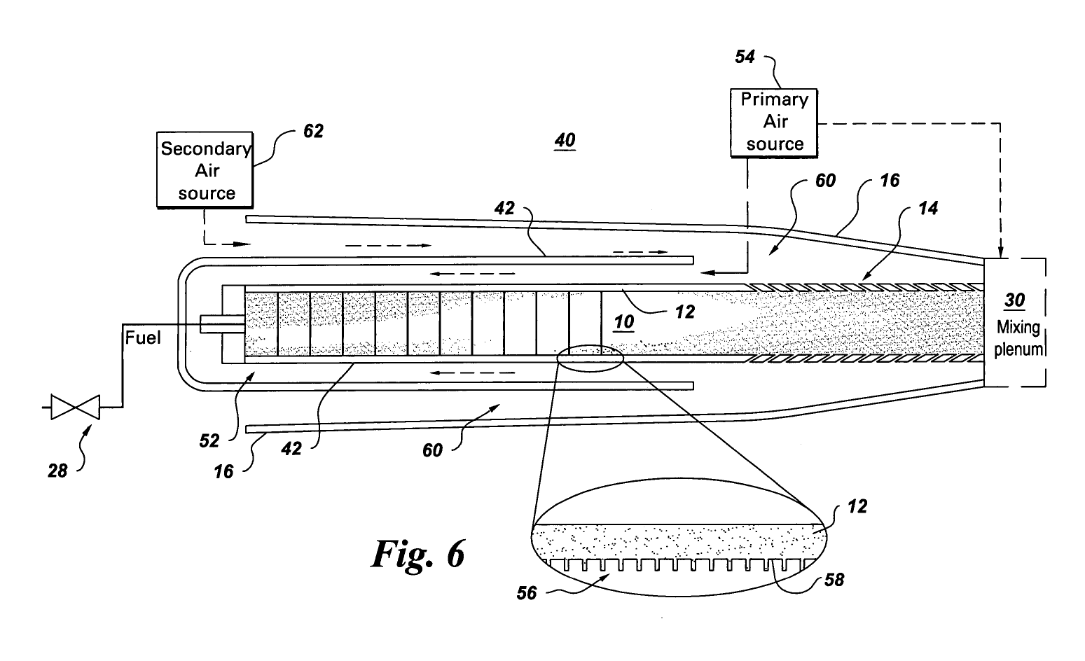

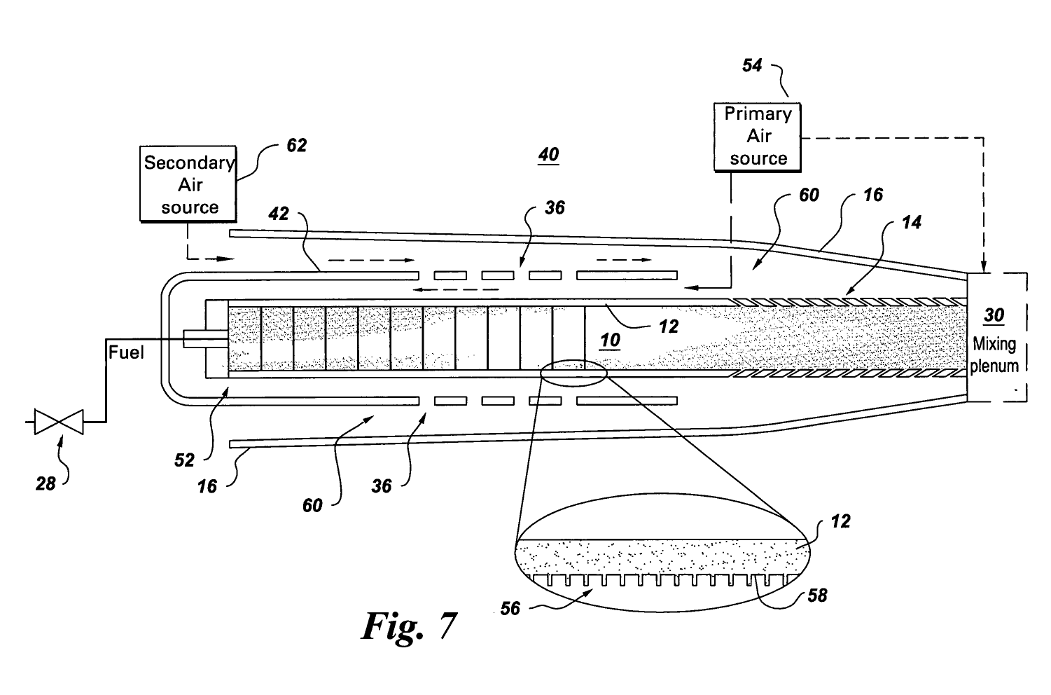

Returning to FIG. 1, the cooling holes 14, more particularly, are film cooling holes 14 configured for film cooling PD chamber 10. Beneficially, the film cooling holes both cool PD chamber 10 and reduce noise from firing the PD chamber. Film cooling holes 14 are described in more detail with reference to FIG. 2. According to a particular embodiment, film cooling holes 14 are arranged at an angle α in a range of about five to about forty-five degrees relative to wall 12. According to more particular embodiments, the film cooling holes 14 are oriented at an angle α of less than about thirty degrees, and more particularly in a range of about five to about thirty degrees relative to the wall 12. For the example arrangement of FIG. 2, the film cooling holes 14 are characterized by a length L and a diameter D. The film cooling holes 14 extend through wall 12, such that the length L is determined by the thickness of the wall 12 and the angle α at which the film cooling hole 14 is oriented relative to the wall 12. For an exemplary embodiment, the ratio of the length L to the diameter D for the film cooling holes is in a range of about two to about ten (L/D˜1-10). For a particular example, L/D˜5. For an example configuration, the film cooling holes 14 have a diameter D in a range of about 0.020 to about 0.090 inches, and a length L of about 0.090 inches. The film cooling holes 14 may be shaped holes, for example cylindrical or oblong holes. According to a particular embodiment, flow control through cooling holes 14 is achieved by angling the outer wall 16, such that the flow velocity remains constant in the bypass section as the mass flow is depleted through the holes. See, for example, FIG. 6.

According to a particular embodiment, at least one of the film cooling holes 14 has a chamfered opening 20. In one exemplary embodiment, each of the film cooling holes 14 has a chamfered opening 20. FIG. 3 shows a cooling hole 14 with a chamfered opening 20. The dashed arrow in FIG. 3 indicates the flow of air through cooling hole 14.

As indicated, for example, in FIG. 1, PD chamber 10 is configured to receive a primary air (oxidizer) flow and a fuel flow. As used herein, the phrase “primary air” should be understood to refer to the air (or other oxidizer) supplied to the PD chamber 10 for the primary detonation in the PD chamber 10. For this exemplary configuration, PD assembly 30 further includes an air source 22 configured to supply a secondary air flow to bypass region 18. Film cooling holes 14 are configured to receive at least a portion of the secondary air flow from bypass region 18 and to convey the respective portion of the secondary air flow into the PD chamber 10 to cool the PD chamber 10. As used herein, “secondary air” should be understood to mean air not supplied to the PD chambers. Together, the primary and secondary air compose the overall air supply. For example, both the primary air (oxidizer) flow and secondary air flow may be supplied by bleed air from a compressor (not shown). As used herein the term “air” should be understood to mean an oxidizer. For example and without limitation, “air” can be oxygen and/or compressed air. For the exemplary embodiment of FIG. 1, the secondary airflow is supplied to the bypass region 18 via a secondary air controlling orifice 26 and the fuel is supplied to PD chamber 10 via a high frequency fuel control valve 28. A few examples of fuel types include, without limitation, hydrogen, distillate fuels and natural gas. Exemplary distillate fuel include, without limitation, diesel fuel #2, Jet A fuel, kerosene and JP8.

For the exemplary configuration of FIG. 1, PD assembly 50 further includes a mixing plenum 30 configured to receive excess secondary air flow from bypass region 18 and a plurality of detonation by-products from PD chamber 10.

One challenge associated with pulse detonation is cooling the PD chamber 10. The interior of PD chamber 10 is exposed to extremely hot detonation products (on the order of 2000 degrees Celsius) and thus requires more thermal management than does the relatively cool outer surface of the PD chamber 10, which may itself be at a temperature of about 500 degrees Celsius. Film cooling cools the PD chamber 10 by flowing the relatively cool secondary air from the cooler exterior of the PD chamber 10 to the hot interior of PD chamber 10. The cooler secondary air forms a protective “film” between the hot interior surface of the PD chamber and the hot detonation products, thereby helping protect the PD chamber 10 from overheating.

In addition, acoustic loads produced by firing PD chamber 10 pose noise challenges. Beneficially, incorporation of film cooling holes 14 in PD chamber 10 helps to reduce the acoustic loads as follows. When the detonation wave encounters the film cooling holes 14, mass flow into and/or through the cooling holes 14 attenuates the acoustic waves. Consequently, the exhaust from PD chamber 10 creates a lower and more gradual pressure rise, reducing noise.

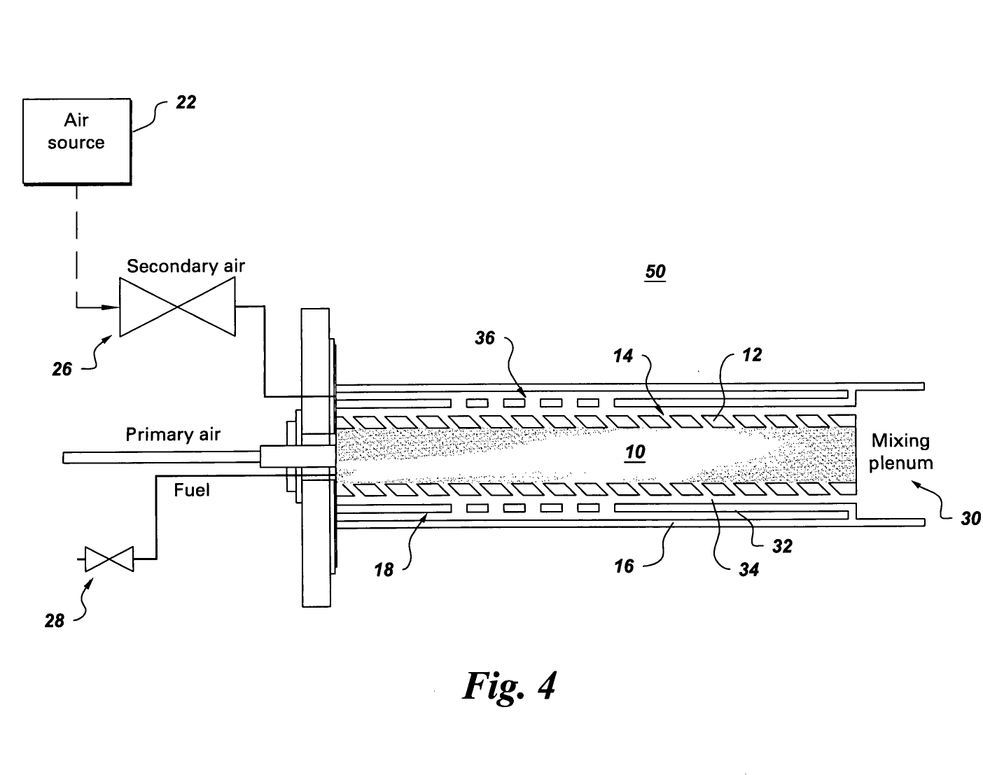

FIG. 4 illustrates a PD assembly with both impingement and film cooling. For the exemplary embodiment of FIG. 4, the PD assembly 50 further includes a sleeve 32 disposed between the PD chamber(s) 10 and manifold 16. The sleeve 32 extends around the PD chamber(s) 10. As indicated, the manifold 16 and sleeve 32 are separated by bypass region 18, and the sleeve 32 and PD chamber 10 are separated by an impingement cooling discharge reservoir 34. The sleeve defines a number of slots 36, which slots 36 are arranged along at least a portion of the sleeve 32. More particularly, the slots 36 are impingement cooling slots 36 configured to receive at least a portion of the secondary air flow from bypass region 18. For this exemplary embodiment, the slots 36 are arranged along an upstream portion of the sleeve 32. Similarly, the film cooling holes 14 are arranged along a downstream portion of PD chamber 10 and are configured to receive a portion of the secondary air flow from impingement cooling discharge reservoir 34. Beneficially, the impingement slots 36 create high velocity jets that impinge on the outer surface of the PD chamber(s) 10.

Still more particularly, for the exemplary embodiment of FIG. 4, sleeve 32 is attached to manifold 16, and the impingement cooling slots 36 are configured to convey the secondary air flow from bypass region 18 to impingement cooling discharge reservoir 34. For this exemplary embodiment, PD assembly 50 further includes a mixing plenum 30 configured to receive an impingement cooling discharge flow from the impingement cooling discharge reservoir 34 and a number of detonation by-products from PD chamber 10.

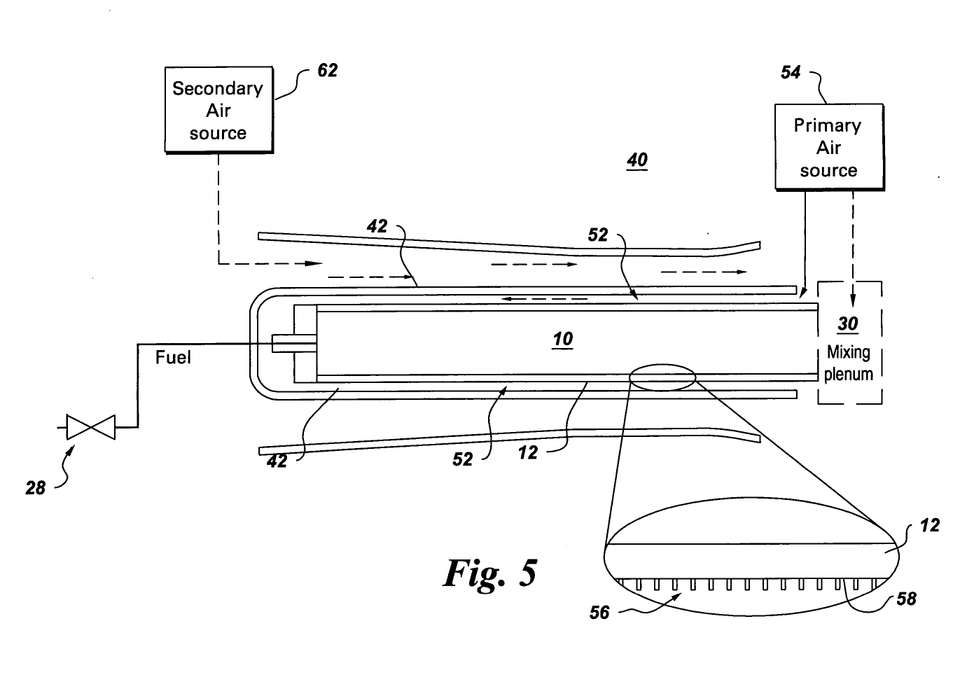

Several pulse detonation PD assembly 40 embodiments with reverse flow cooling are described with reference to FIGS. 5-8. For the exemplary embodiment illustrated by FIG. 5, PD assembly 40 includes at least one PD chamber 10 that include a wall 12. PD assembly 40 further includes a sleeve 42 extending around the PD chamber(s) 10. The sleeve 42 and PD chamber 10 are separated by a reverse flow cooling passage 52. Sleeve 42 may extend along the entire length of PD chamber 10 as shown in FIG. 5 or along only a portion of the length of the PD chamber, as shown for example in FIGS. 6-8. The reverse flow cooling passage 52 is configured to receive a flow of air and to flow the air in a reverse direction to supply the PD chamber 10, as indicated by the respective dashed arrows in FIG. 5.

The PD assembly 40 shown in FIG. 5 further includes an air source 54 configured to supply primary air to the reverse flow cooling passage 52. Supplying the primary air to PD chamber(s) 10 via reverse cooling passage 52 beneficially cools the PD chamber(s) 10 and preheats the primary air. Although the primary and secondary air sources 54, 62 are shown in FIGS. 5 and 6 as two separate sources, those skilled in the art will recognize that the primary and secondary air can be supplied by the same source (for example a tank or a compressor), and the claims should not be limited to separate air sources. In fact, the distribution of secondary air (supplied to mixing plenum 30, either directly as shown or via the bypass region 60) and primary air (supplied to PD chamber(s) 10 via reverse flow cooling passage 52) can be used to control the power of PD assembly 40.

According to a more particular embodiment and as indicated in the enlarged region of interest in FIG. 5, PD assembly 40 further includes a number of heat transfer enhancements 56 formed on an exterior surface 58 of wall 12. The heat transfer enhancements 56 are configured to enhance heat transfer from PD chamber(s) 10 to reverse flow cooling passage 52. Examples of heat transfer enhancements 56 include dimples, turbulators, transverse ribs, and turbulence promoters. Beneficially, inclusion of heat transfer enhancements 56 on the cold surface 58 of wall 12 enhances the cooling of wall 12 by the primary air flowing through reverse flow cooling passage 52. Enhanced heat transfer is discussed generally in Webb, Ralph L., Principles of Enhanced Heat Transfer, Chapter 9, John Wiley & Sons, Inc., 1994.

The exemplary arrangement of FIG. 6 combines reverse flow cooling with film cooling. As indicated in FIG. 6, wall 12 of PD chamber 10 defines a number of film cooling holes 14 arranged along at least a downstream portion of the PD chamber 10. As illustrated in FIG. 6, sleeve 42 extends along an upstream portion of PD chamber(s) 10. For the exemplary embodiment of FIG. 6, PD assembly 40 further includes a manifold (for example, an annular manifold) 16 extending around sleeve 42 and PD chamber(s) 10. As indicated, the manifold 16 is separated from the sleeve 42 and PD chamber(s) 10 by a bypass region 60.

For the exemplary embodiment of FIG. 6, the PD assembly 40 further includes a secondary air source 62 configured to supply a secondary air flow to bypass region 60. The film cooling holes 14 are configured to receive at least a portion of the secondary air flow from bypass region 60 and to convey the respective portion of the secondary air flow into the PD chamber(s) 10 to cool the PD chamber(s) 10. More particularly, the PD assembly 40 further includes a mixing plenum 30 configured to receive excess secondary air flow from bypass region 60 and a number of detonation by-products from PD chamber 10.

FIG. 7 illustrates another exemplary arrangement that combines reverse flow cooling, impingement cooling and film cooling. The arrangement of FIG. 7 is similar to that of FIG. 6 and further includes a number of impingement cooling slots 36 formed in sleeve 42 and that are configured to receive a portion of the secondary air flow from bypass region 60 and arranged along an upstream portion of sleeve. As indicated in FIG. 7, the film cooling holes 14 are arranged along the downstream portion of PD chamber(s) 10.

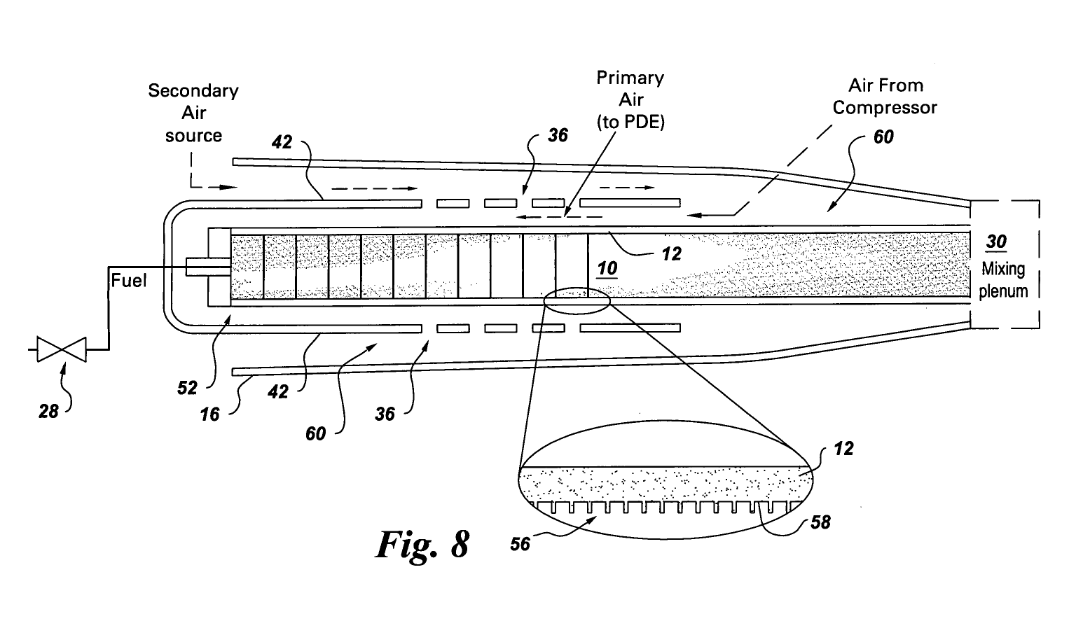

FIG. 8 depicts another exemplary PD assembly arrangement that combines reverse flow cooling and impingement cooling. The arrangement of FIG. 8 is similar to that of FIG. 7 but does not include film cooling holes. Rather, sleeve 42 defines a number of impingement cooling slots 36 configured to receive a portion of the secondary air flow and arranged along at least a portion of sleeve 42. Heat transfer enhancements (turbulators) 56 can be advantageously combined with the other reverse flow cooling embodiments of PD assembly 40. For example, the turbulators 56 can be combined with the impingement cooling slots of FIG. 8. As shown in FIG. 8, sleeve 42 defines a number of impingement cooling slots 36 configured to receive a portion of the secondary air flow and arranged along an upstream portion of sleeve 42. As indicated in the enlarged region of FIG. 8, PD assembly 40 further includes a number of turbulators 56 formed on an exterior surface 58 of the wall 12, where the turbulators 56 are configured to enhance heat transfer from the PD chamber(s) 10 to the reverse flow cooling passage 52.

Similarly, heat transfer enhancements (turbulators) 56 can be combined with the impingement cooling slots and film cooling holes of FIG. 7. As indicated in FIG. 7, the manifold 16 is separated from the sleeve 42 and PD chamber(s) 10 by a bypass region 60. For the exemplary embodiment of FIG. 7, film cooling holes 14 are arranged along a downstream portion of the PD chamber(s) 10, and the sleeve 42 extends along an upstream portion of PD chamber(s) 10. Turbulators 56 are formed on an upstream portion of wall 12, in order to enhance the reverse flow cooling of wall 12 of PD chamber 10.

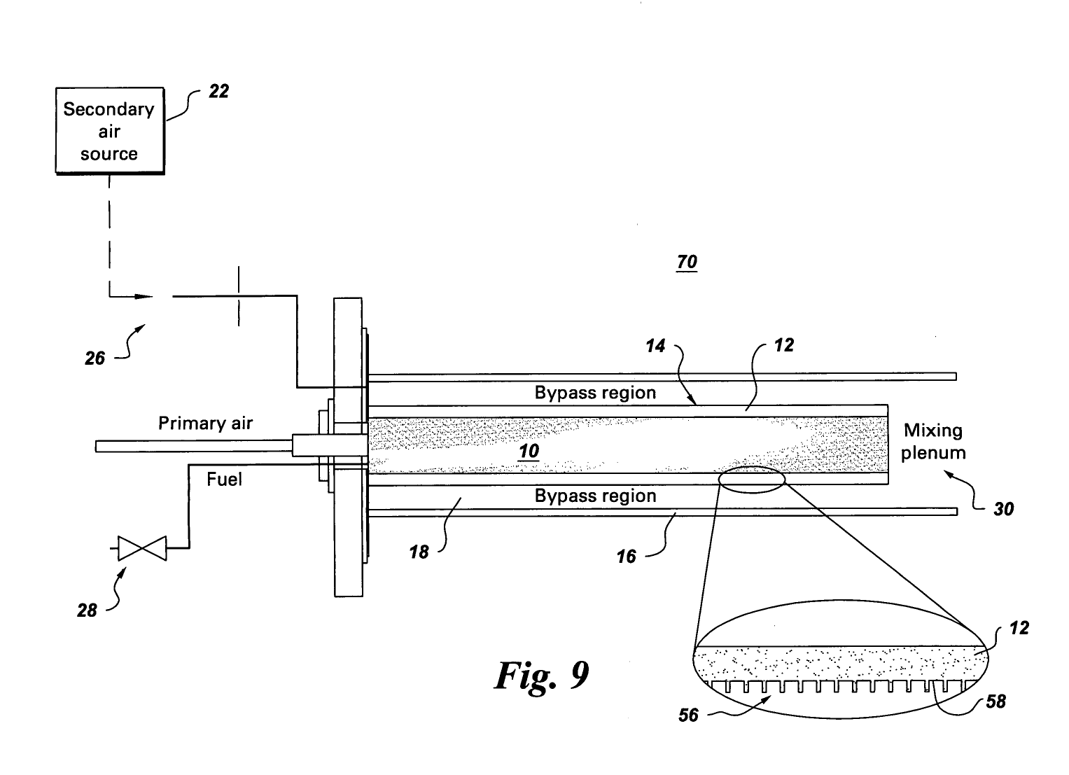

A bypass flow cooling pulse detonation (PD) assembly 70 embodiment is described with reference to FI G. 9. As shown in FIG. 9, the PD assembly 70 includes at least one PD chamber 10 comprising a wall 12. The PD assembly 70 further includes a manifold 16 extending around the PD chamber(s) 10. As indicated in FIG. 9, the manifold 16 and PD chamber 10 are separated by a bypass region 18 configured to receive and conduct a bypass flow. For the exemplary embodiment shown in FIG. 9, the PD assembly 70 further includes a mixing plenum 30 configured to receive and mix the bypass flow from the bypass region 18 and the detonation by-products from the PD chamber(s) 10. However, the bypass flow does not necessarily have to mix with the primary flow in the mixing plenum immediately downstream of the PD chamber 10. For example, in one configuration (not shown) the mixing occurs further downstream in the engine, for example after one or two stages of the turbine. For the exemplary embodiment depicted in FIG. 9, the PD assembly 70 includes a number of heat transfer enhancements 56 formed on an exterior surface 58 of the wall 12. Beneficially, the heat transfer enhancements 56 are configured to enhance heat transfer from the PD chamber 10 to the bypass region 18. Exemplary heat transfer enhancements 56 include turbulators 56.

Beneficially, the embodiments described above employ one or more of the following cooling techniques: bypass flow cooling, film cooling, impingement cooling and reverse flow cooling. In addition, the reverse flow cooling is advantageously combined with heat transfer enhancements (turbulators) in certain embodiments. These cooling techniques help to address the overheating concerns at issue for practical applications of pulse detonation engines. In addition, certain of these techniques (e.g. film cooling) help to suppress noise associated with the firing of the pulse detonation engines.

Although only certain features of the invention have been illustrated and described herein, many modifications and changes will occur to those skilled in the art. It is, therefore, to be understood that the appended claims are intended to cover all such modifications and changes as fall within the true spirit of the invention.

1. A pulse detonation (PD) assembly comprising:
at least one PD chamber comprising a wall which defines a plurality of cooling holes, wherein said cooling holes are arranged along at least a portion of said PD chamber; and
a manifold extending around said at least one PD chamber, wherein said manifold and said PD chamber are separated by a bypass region.

2. The PD engine assembly of claim 1, wherein said cooling holes comprise film cooling holes configured for film cooling said PD chamber.

3. The PD assembly of claim 2, wherein said film cooling holes are arranged at an angle in a range of about zero to about forty-five degrees relative to said wall.

4. The PD assembly of claim 2, wherein at least one of said film cooling holes has a chamfered opening.

5. The PD assembly of claim 1, wherein said at least one PD chamber is configured to receive a primary air flow and a fuel flow, said PD assembly further comprising:
an air source configured to supply a secondary air flow to said bypass region, and wherein said cooling holes are configured to receive at least a portion of the secondary air flow from said bypass region and to convey the respective portion of the secondary air flow into the PD chamber to cool the PD chamber.

6. The PD assembly of claim 5, further comprising a mixing plenum configured to receive excess secondary air flow from said bypass region and a plurality of detonation by-products from said PD chamber.

7. The PD assembly of claim 5, further comprising a sleeve disposed between said at least one PD chamber and said manifold, wherein said sleeve extends around said at least one PD chamber, wherein said manifold and said sleeve are separated by the bypass region, wherein said sleeve and said PD chamber are separated by an impingement cooling discharge reservoir, wherein said sleeve defines a plurality of slots, and wherein said slots are arranged along at least a portion of said sleeve.

8. The PD assembly of claim 7, wherein said slots comprise impingement cooling slots configured to receive at least a portion of said secondary air flow from said bypass region, wherein said slots are arranged along an upstream portion of said sleeve, and wherein said cooling holes are arranged along a downstream portion of said PD chamber and are configured to receive a portion of the secondary air flow from said impingement cooling discharge reservoir.

9. The PD assembly of claim 8, wherein said sleeve is attached to said manifold, wherein said impingement cooling slots are configured to convey the secondary air flow from said bypass region to said impingement cooling discharge reservoir, said PD assembly further comprising a mixing plenum configured to receive an impingement cooling discharge flow from said impingement cooling discharge reservoir and a plurality of detonation by-products from said PD chamber.

10. A pulse detonation (PD) assembly with reverse flow cooling, said PD assembly comprising:
at least one PD chamber comprising a wall; and
a sleeve extending around said at least one PD chamber, wherein said sleeve and said PD chamber are separated by a reverse flow cooling passage configured to receive a flow of air and to flow the air in a reverse direction to supply said PD chamber.

11. The PD assembly of claim 10, further comprising an air source configured to supply primary air to said reverse flow cooling passage, wherein said reverse flow cooling passage is configured to supply the primary air to said at least one PD chamber.

12. The PD assembly of claim 11, further comprising a plurality of heat transfer enhancements formed on an exterior surface of said wall, wherein said heat transfer enhancements are configured to enhance heat transfer from said PD chamber to said reverse flow cooling passage.

13. The PD assembly of claim 11, wherein said wall defines a plurality of film cooling holes arranged along at least a downstream portion of said PD chamber, and wherein said sleeve extends along an upstream portion of said at least one PD chamber, said PD assembly further comprising:
a manifold extending around said sleeve and said at least one PD chamber, wherein said manifold is separated from said sleeve and said PD chamber by a bypass region; and
a secondary air source configured to supply a secondary air flow to said bypass region.

14. The PD assembly of claim 13, wherein said film cooling holes are configured to receive at least a portion of the secondary air flow from said bypass region and to convey the respective portion of the secondary air flow into the PD chamber to cool the PD chamber.

15. The PD assembly of claim 14, further comprising a mixing plenum configured to receive excess secondary air flow from said bypass region and a plurality of detonation by-products from said PD chamber.

16. The PD assembly of claim 14, wherein said sleeve defines a plurality of impingement cooling slots configured to receive a portion of the secondary air flow from said bypass region and arranged along an upstream portion of said sleeve, and wherein said film cooling holes are arranged along the downstream portion of said PD chamber.

17. The PD assembly of claim 11, wherein said sleeve defines a plurality of impingement cooling slots configured to receive a portion of the secondary air flow from said bypass region and arranged along at least a portion of said sleeve.

18. A pulse detonation (PD) assembly with reverse flow cooling, said PD assembly comprising:
at least one PD chamber comprising a wall;
a sleeve extending around said at least one PD chamber, wherein said sleeve and said PD chamber are separated by a reverse flow cooling passage;
an air source configured to supply primary air to said reverse flow cooling passage, wherein said reverse flow cooling passage is configured to receive the primary air and to supply the primary air to said at least one PD chamber; and
a plurality of heat transfer enhancements formed on an exterior surface of said wall, wherein said heat transfer enhancements are configured to enhance heat transfer from said PD chamber to said reverse flow cooling passage.

19. The PD assembly of claim 18, further comprising:
a manifold extending around said sleeve and said at least one PD chamber, wherein said manifold is separated from said sleeve and said PD chamber by a bypass region;
a secondary air source configured to supply a secondary air flow to said bypass region; and
a mixing plenum configured to receive excess secondary air flow from said bypass region and a plurality of detonation by-products from said PD chamber,
wherein said wall defines a plurality of film cooling holes arranged along a downstream portion of said PD chamber,
wherein said sleeve extends along an upstream portion of said at least one PD chamber, and
wherein said film cooling holes are configured to receive at least a portion of the secondary air flow from said bypass region and to convey the respective portion of the secondary air flow into the PD chamber to cool the PD chamber.

20. The PD assembly of claim 19, wherein said sleeve defines a plurality of impingement cooling slots configured to receive a portion of the secondary air flow and arranged along an upstream portion of said sleeve.

21. The PD assembly of claim 18, wherein said heat transfer enhancements comprise turbulators.

22. A pulse detonation (PD) assembly comprising:
at least one PD chamber comprising a wall; and
a manifold extending around said at least one PD chamber, wherein said manifold and said PD chamber are separated by a bypass region configured to receive and conduct a bypass flow.

23. The PD assembly of claim 22, further comprising a mixing plenum configured to receive and mix the bypass flow from said bypass region and a plurality of detonation by-products from said PD chamber.

24. The PD assembly of claim 23, further comprising a plurality of heat transfer enhancements formed on an exterior surface of said wall, wherein said heat transfer enhancements are configured to enhance heat transfer from said PD chamber to said bypass region.

25. The PD assembly of claim 24, wherein said heat transfer enhancements comprise turbulators.
